(19) United States
(12) Patent Application Publication
(10) Pub. No.: US 2022/0357637 A1
(43) Pub. Date: Nov. 10, 2022

(54) Magnetic monopod apparatus for supporting an electronic device

(71) Applicant: Paul Park, Wayne, NJ (US)

(72) Inventor: Paul Park, Wayne, NJ (US)

(21) Appl. No.: 17/316,501

(22) Filed: May 10, 2021

(51) Int. Cl. G03B 17/56; H01F 7/02; F16M 11/22; F16M 11/14; F16M 11/04; F16M 11/16

(52) U.S. Cl. CPC G03B 17/561; H01F 7/02; F16M 11/22; F16M 11/14; F16M 11/041; F16M 11/16

(57) ABSTRACT

This invention relates to a monopod device for use with a phone, tablet, camera, and other recording devices that is supported by the monopod and is inserted into the ground to provide hands-free photographing, video recording, and streaming of music and video. The monopod device includes a magnetic mounting system for electronic devices, silicone covered threaded magnet, ferrous metal plate with adhesive, rotational adjustment mechanism, and non-collapsible support hollow shaft. The hollow shaft with a pointed plug is constructed to be inserted into the ground to provide stable hands-free filming and use of the electronic device. The rotational adjustment mechanism having a swivel secures the threaded magnet allows different filming and viewing angles. The threaded magnet provides powerful pulling power that allows coupling of small electronic devices. This invention has a cradle free design providing safe and easy one-handed device use. The invention provides a solution to filming sports motion.

### FIELD OF THE INVENTION

The present invention relates to a monopod apparatus for magnetically supporting and mounting an electronic device that is inserted into the ground for the purpose of hands-free photography, videography, and streaming.

### BACKGROUND OF THE INVENTION

Sports athletes practice to improve performance persistently. Particularly, golf is recognized as one of the most difficult and competitive sports. While there are many well-known methods and practices, the integration of technology and biomechanical data has become more prevalent in the sports industry to assist athletes in improving performance. Some methods include training with professionals and training alone with self-teaching tutorials. Working with professional trainers or instructors can be costly and practicing alone lacks the in-depth analysis to critical improvement observations. There is an inherent need to record, monitor, and analyze a player's performance, such as a golf swing, for improved results.

This invention is specifically for documenting golf swings. During training and practice, digital documentation is essential to reviewing and analyzing for progressive improvement. Electronic devices such as digital cameras, phones, iPads, GoPro, and many other portable digital devices are often positioned at specific angles and orientations to optimize the field view.

There are many self-standing tripods and mounting apparatuses for documenting on an electronic device well known in the market. However, tripods and mounting apparatuses can be large, heavy, unstable in the wind, and cumbersome to travel around with. In other cases, the mounting apparatuses are flimsy and difficult to attach and detach the digital device onto the mounting apparatus. The electronic device is often secured to the mounting apparatus with a clamp mechanism or a threaded fastener. Such attachment mechanisms require a plurality of parts and multiple steps in the assembly process.

The magnetic monopod apparatus is directed to resolve and improve the problems of existing mounting apparatuses. The apparatus provides hands-free viewing access to the electronic device so a user is able to review recordings of a sports motion to analyze and improve a play. The apparatus facilitates the easy securing of an electronic device to the ground inserted monopod with one hand with a magnet. Furthermore, a swiveling mechanism is provided to allow a 90-degree angular rotation adjustment of the electronic device, a range from a recording angle substantially parallel to the ground surface to a substantially vertical orientation with the axis of rotation at the center of a swivel ball, while supported to the monopod apparatus. As digital content has become readily available, golfers and other athletes are able view their electronic device at a preferred angle whether they are streaming their favorite sports play or viewing data outputted by a golf simulator. The invention has a cradle free design that permits safe and easy one-handed device use.

### SUMMARY OF THE INVENTION

The present invention improves and resolves the aforementioned challenges by providing an athlete with a lightweight, ergonomic monopod apparatus that is easily assembled and ready to use for documenting sports motion, that is specifically but not limited to a golf swing. The present invention provides a hollow rod designed for ground insertion with a magnetic component to facilitate the attachment of an electronic device having a ferrous material attached. The electronic device includes and is not limited to a digital camera, smartphone, tablet computer, or GoPro. The electronic device is securely fastened to the monopod by the magnetic attachment that is easily repositioned with a single hand.

An object of the present invention is to provide a magnetic mounting monopod apparatus for an electronic device for the purpose of filming sports motion, filming personal content, and hands-free video and music streaming comprising: a hollow rod comprising a TPE grip top portion, ground insertion base, and threaded protrusion upper end; an adjustable magnetic mounting assembly, comprising a silicone sleeve covered magnet coupled to a swivel ball head, wherein the swivel ball head comprises an adjustable 90 degree swivel; a ferrous metal plate with an adhesive layer provided to attach to the electronic device; the swivel ball head supported within a swivel socket having a threaded hole for a twist locking mechanism.

The advantages of the present invention are: (1) magnetic monopod apparatus is designed for ground insertion and the support rod is inserted directly into the ground for a stable support and hands-free function; (2) the magnetic monopod device inserted into the ground provides a stable support when it is windy, preventing the swaying and knock down of alternative supports that rest on the surface of the ground; (3) the magnetic attachment mechanism allows any electronic device having a ferrous magnetic plate or material to easily mount and dismount to the magnet; (4) the magnetic attachment mechanism allows the user to easily adjust the orientation of the electronic device from portrait to landscape orientation and to attach and detach with one hand; (5) the magnetic monopod apparatus allows users to film sports motion, personal content, and view content on the electronic device without anyone's assistance; (6) the magnetic monopod apparatus comprising a top head is constructed to adjust the orientation of the electronic device along the range of 360-degrees by adjusting a swivel socket; (7) the magnetic monopod apparatus having the hollow support rod is constructed with material that is 10× stronger than steel and 5× lighter. The magnetic monopod apparatus is easy-to-use, lightweight, portable, and convenient.

Although the present invention is briefly summarized, the fuller understanding of the invention can be obtained by the following drawings, detailed description, and appended claims.

### BRIEF DESCRIPTION OF THE DRAWINGS

These and other features, aspects and advantages of the present invention will become better understood with reference to the accompanying drawings, wherein:

FIG. 1 shows a side perspective view of a magnetic monopod apparatus according to one embodiment of the present invention;

FIG. 2 shows a rear perspective view of the magnetic monopod apparatus with details of the rotational adjustment mechanism of the embodiment shown in FIG. 1;

FIG. 3 shows a side perspective view of an electronic device, specifically a smart phone, attached to a magnetic component of the magnetic monopod apparatus according to one embodiment of the present invention;

FIG. 4 shows a front perspective view of a magnetic monopod apparatus with details of the rotational adjustment mechanism according to one embodiment of the present invention;

FIG. 5 shows an exploded side perspective view of the magnetic monopod apparatus mounting assembly of a monopod device according to one embodiment of the present invention;

FIG. 6 shows a rear perspective view of a magnetic component of the magnetic monopod apparatus according to one embodiment of the present invention;

FIG. 7 shows a front view of the magnetic component head comprising individual magnets according to one embodiment of the present invention;

FIG. 8 shows a perspective view of the magnetic monopod apparatus with the magnetic component rotated in the 90-degree position according to one embodiment of the present invention.

### DETAILED DESCRIPTION EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

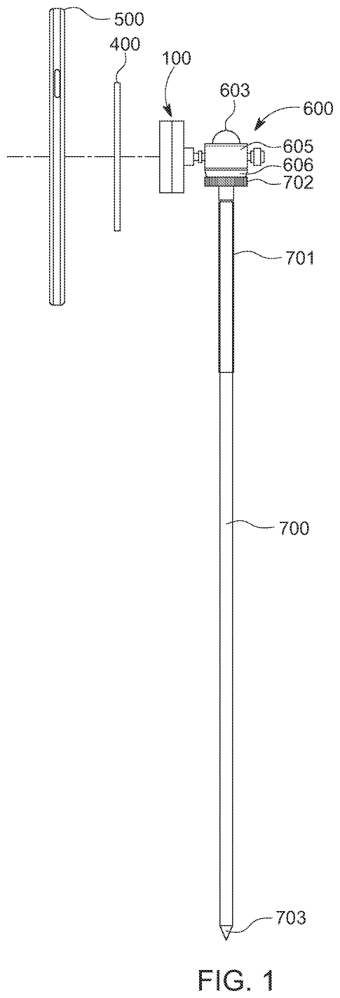

FIG. 1 shows a side view of a magnetic monopod apparatus comprising a monopod device support rod 700, an electronic device that is a smart phone 500 attached to a magnetic component 100 by means of an attachment that is a magnetic attachment plate made of a ferrous metal material 400 according to one embodiment of the present invention.

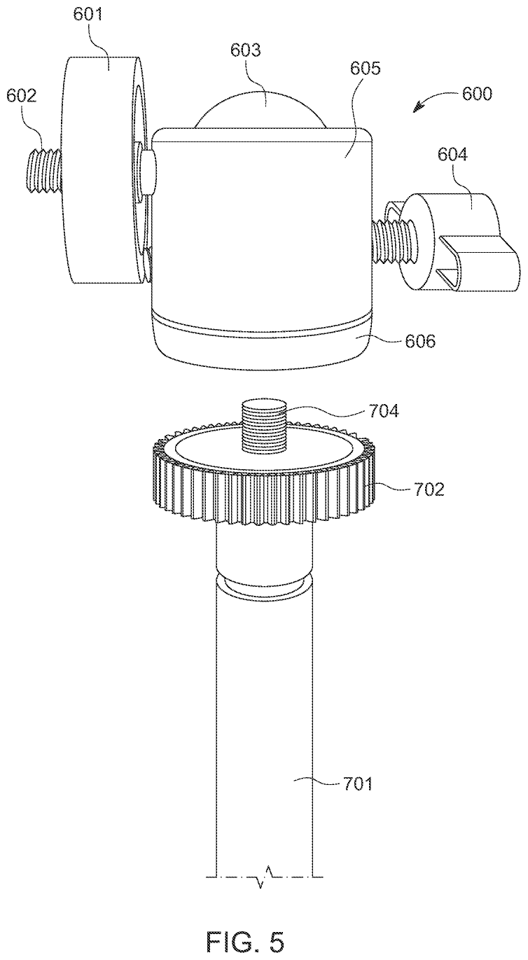

As shown in FIGS. 1-3 the magnetic monopod apparatus having the monopod device support rod 700, is adapted to be inserted into the ground to document sports motion. The support rod 700, in this embodiment, includes a ground insertion base 703 that is tapered at the bottom end to assist in the ground insertion. The support rod 700 is further provided with a top portion made of a thermoplastic elastomer grip 701 to assist a user when gripping and handling the apparatus. The top portion of the support rod 701 is attached to a cylinder base 702 having a threaded protrusion 704 that is an attachment mechanism to the rotational adjustment mechanism 600. The details of this attachment will be discussed further in the description of FIG. 5. The support rod 700 may be made of wood, carbon fiber, steel, aluminum, another metal, PVC, another plastic, or the like.

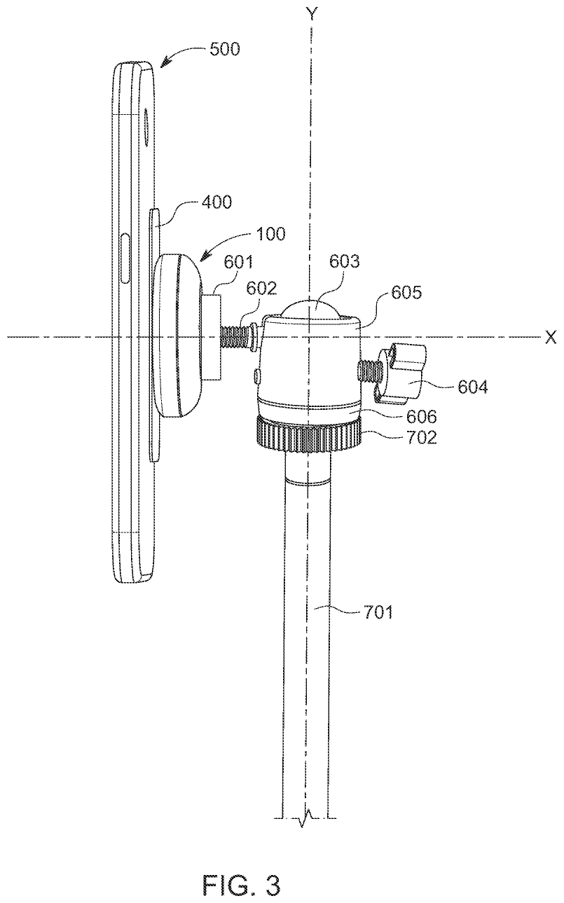

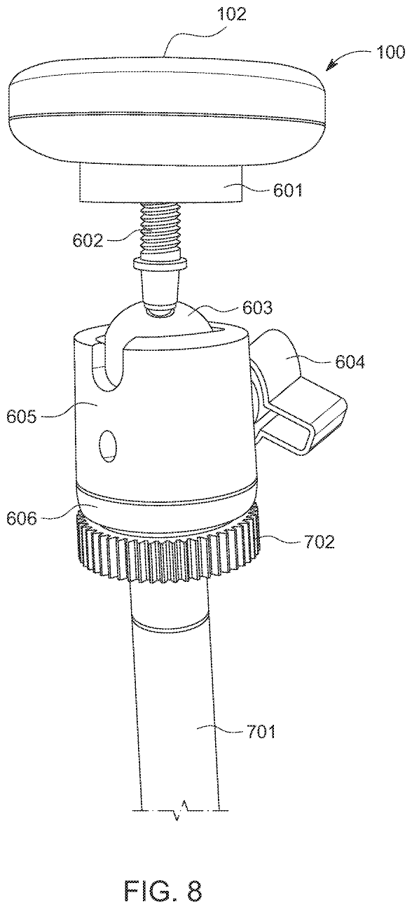

The rotational adjustment mechanism 600 rotates the position of the electronic device at various angles. The angles of rotation of the electronic device are further illustrated in FIG. 3. The rotational adjustment mechanism 600 comprises a swivel ball 603 that is fixedly secured to the magnetic component 100 which securely attaches to the electronic device 500. Swivel ball 603 is rotatable 180 degrees along an X-axis, as shown in FIG. 3. The initial position of the swivel ball 603 is further comprised of a threaded screw 602 fixed, by means of welding or the like, onto the swivel ball. The threaded screw 602 rests in a notch along the top periphery of the swivel socket 605. The notch is further shown in detail in FIG. 8. Once the swivel ball 603 is rotated so that the threaded screw 602 is oriented above the top periphery of the swivel socket, the rotation of the swivel ball can rotate about the Y-axis to facilitate a 360-degree rotation.

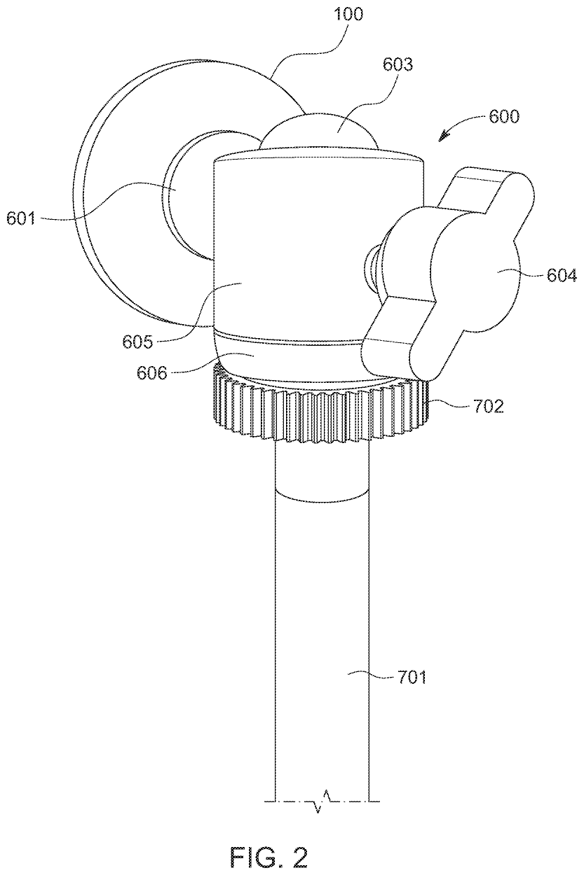

FIG. 2 shows the variable rotation positions provided by the swivel ball 603 which is locked into a desired position by a twist lock 604. The twist lock 604 is configured to tighten the swivel socket 605 to a swivel socket base 606, thereby locking the swivel ball 603 in place. In reverse, the twist lock 604 is also able to loosen the connection between the swivel socket 605 and swivel socket base 606 to free the position of the swivel ball 603 to facilitate the position of the mounted electronic device 500.

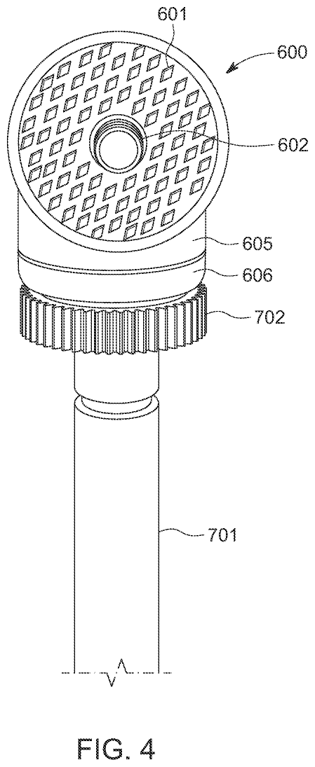

In accordance to FIGS. 4-7 details of the magnetic component is shown. The threaded screw 602 projects from the swivel ball 603. The threaded screw 602 receives a cylindrical threaded base plate 601 that functions as a spacer or washer piece to be in between the swivel.

FIG. 4 shows the monopod support rod 700 top portion 701 having the TPE grip further provided with the cylindrical base 702. FIG. 5 shows the cylindrical base 702 provides a sit surface to restrict and support the threaded connection of the swivel socket base 606. The projection extending from the cylindrical base, threaded projection 704, is inserted into a threaded opening on the bottom surface of the swivel socket base 606 and securely fastened to fix the components comprising the swivel mechanism. The threaded projection 704 is a universal ¼″ inch threaded screw 704 that is compatible with most camera ball heads. A camera device can secure directly to the ¼″ threaded screw 704 in an alternative embodiment directly unto the support rod 700.

FIG. 5 further shows the swivel socket 605 that provides a housing for the swivel ball 603. The swivel socket bottom is attached to the swivel socket base 606 and the notch at the top periphery of the swivel socket. On an opposite surface along the swivel socket cylindrical body from the notch is an opening that receives the twist lock 604. The twist lock 604 rotates to lock the position of the swivel ball 603. When the twist lock 604 releases the hold of the swivel ball 603, the electronic device 500 can be positioned from an orientation as shown in FIG. 3, wherein the electronic device can film and document in a directly parallel to the axis of the monopod support rod 700. The orientation of the electronic device 500 can be adjusted to be perpendicular to the monopod support rod 700 as shown in FIG. 8. The swivel ball 603 facilitates the rotation of the digital device 500 further along the range that the threaded projection of the swivel ball 602 along the upper periphery of the swivel socket 605.

As the threaded protrusion 602 from the swivel ball 603 extends and rests within the notch of the swivel socket 605, the cylindrical threaded base plate 601 having a threaded opening is screwed onto the threaded protrusion 602 and is assembled together as shown in FIG. 5. The cylindrical threaded base plate 601 is provided to be a buffer or washer between the magnetic component 100 and the swivel socket 605. After the cylindrical threaded base plate 601 is securely screwed and fastened onto the threaded protrusion 602, the magnetic component 100 is also securely screwed and fastened onto the threaded protrusion 602 on the threaded opening of the magnetic component 101, as shown in FIG. 3 and FIG. 8.

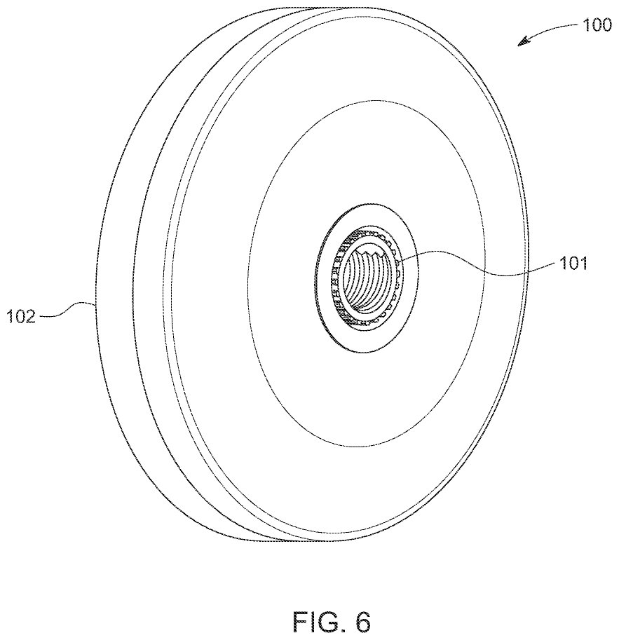

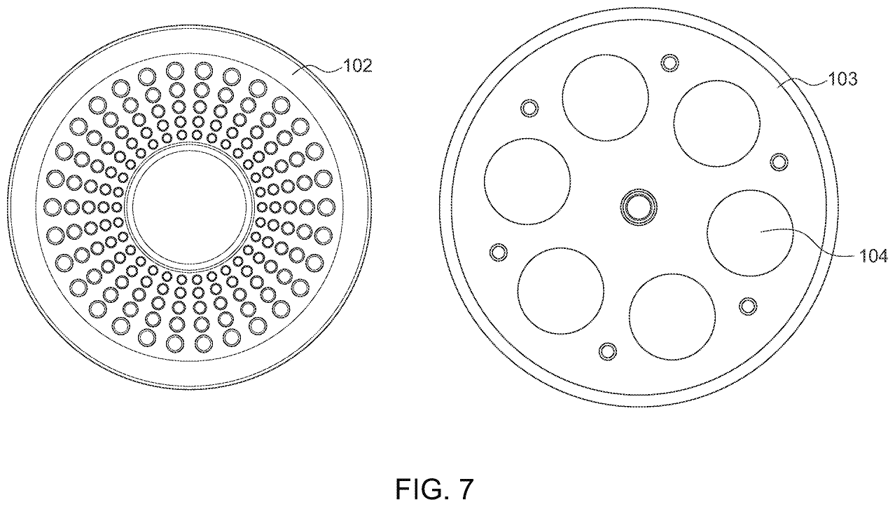

FIG. 6 and FIG. 7 illustrate the magnetic component 100 in detail. The magnetic component 100 includes a magnetic base 103 made of a metal base plate with a plurality of magnets 104 embedded onto the metal base plate. The magnetic base 103 may support one or more magnets 104 according to the desired magnetic flux power. The magnetic base 103 may be coated with silicone, rubber, plastic, or the like. According to this embodiment, the magnetic base 103 is covered by a silicone cover 102. The silicone cover 102 provides a soft contact surface for the outer contact surface of the magnetic component. The silicone cover 102 envelopes the entire surface with exposed magnets 104 and the side periphery as shown in FIG. 6. The magnet component 100 engages with the electronic device 500 having a magnetic attachment plate 400.

As shown in FIGS. 1 and 3, the magnetic attachment plate 400 is a thin planar plate made of a ferrous metal material with an adhesive coating on one planar side. The adhesive coating facilitates an attachment means to secure the magnetic attachment plate 400 to the electronic device 500, such as a smart phone. The magnetic attachment plate 400, having the adhesive coating, is attached directly onto the electronic device 500 or on a protective cover of the electronic device. The magnetic attachment plate having the exposed ferrous metal material without the adhesive coating is magnetically attracted to the magnetic component 100 and is thereby securely and magnetically fastened. The magnetic field strength of the magnetic component 100 is sufficient to support the weight of the electronic device 500 and is easily released from attachment when a user repositions or disengages the electronic device 500 from the magnetic monopod apparatus.

FIG. 8 illustrates the magnetic component 100 in the alternative orientation where the electronic device 500 may be positioned to have a field of view perpendicular to the axis of the monopod support rod. In operation, the electronic device 500 with the magnetic attachment plate 400 is removably engaged with the magnetic component 100. The twist lock 604 provides the angular adjustment of the electronic device 500 when mounted to the magnetic component 100 by facilitating the rotational adjustment of the swivel ball 603.

The electronic device 500 as shown in the figures is a smart phone. The magnetic monopod apparatus is able to be used with alternative electronic devices such as but not limited to a phone, tablet computer, camera, GoPro, or the like.

In accordance to this embodiment, the monopod support rod 700 is a single extruded hollow rod with the gripping top portion 701. The monopod support rod 700 may also be provided as a height adjustable support rod to further enhance and assist in the positioning and orientation of the electronic device 500 field of view.

While the magnetic monopod apparatus may be used to record and document various activities, the scope of this invention focuses specifically on recording golf swings and putts for analysis to improve an athlete's performance.

While the invention has been shown and described with reference to one embodiment thereof, it will be appreciated by those skilled in the art that variations in form, detail, compositions and operation may be made without departing from the spirit and scope of the invention as defined by the accompanying claims.

It is worth noting that while specific figures are used, and particular examples have been illustrated, these are non-limiting examples. In certain contexts, two or more elements may be combined, an element may be split into two or more elements, or certain elements may be re-ordered or re-organized as appropriate, as the explicit illustrated examples are used only for descriptive purposes and are not to be construed as limiting.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A magnetic monopod apparatus for mounting an electronic device comprising:
a monopod support rod having a ground insertion base portion for inserting the support rod into a ground surface, a top portion having a gripping portion, an upper end having a threaded protrusion; thereby providing a stable hands-free photography, video recording, and documenting mount for the electronic device;
a swivel socket with a swivel socket base attached to the upper end of the support rod by engaging with the threaded protrusion; the swivel socket having a swivel ball adjustable positioned within the swivel socket; the swivel ball having a cylindrical threaded base plate securely fastened on a protrusion extending from the swivel ball; a twist lock that engages with the swivel socket and swivel socket base to adjust angular rotational of the swivel ball; wherein the swivel ball rotates 180 degrees about a pivot point along an X-axis and a range of rotation 360 degrees about a Y-axis;
wherein a magnetic component is adjacent to the cylindrical threaded base plate, thereby providing an attachment means to securely fasten and support the mounting of the electronic device to the monopod support rod.

2. The magnetic monopod apparatus of claim 1, wherein a magnetic attachment plate made of ferrous magnetic material that is a planar plate with a first side and a second side; wherein the first side having an adhesive layer to attach to the surface of the electronic device; wherein the second side of the magnetic attachment plate engages to the magnetic component.

3. The magnetic monopod apparatus of claim 2, wherein the magnetic component is comprised of a metal base plate having magnets embedded into the metal base plate to provide sufficient magnetic field strength to support a weight of the electronic device; wherein the metal base plate is covered with a silicone cover, thereby providing a soft surface to engage with the electronic device.

4. The magnetic monopod apparatus of claim 2, wherein the magnetic component is provided with enough magnets to support up to 1400 grams.

5. The magnetic monopod apparatus of claim 3, wherein the adhesive layer is attached directly onto the electronic device.

6. The magnetic monopod apparatus of claim 3, wherein the adhesive layer is attached onto a cover of the electronic device.

7. The magnetic monopod apparatus of claim 1, wherein the monopod support rod is a non-collapsible hollow shaft made of materials such as wood, carbon fiber, steel, aluminum, metal PVC, or plastic.

8. The magnetic monopod apparatus of claim 1, wherein the monopod support rod is a collapsible hollow shaft made of materials such as wood, carbon fiber, steel, aluminum, metal PVC, or plastic.

9. The magnetic monopod apparatus of claim 5, wherein the base portion of the monopod support rod has a tapered end to assist in ground insertion for securing the magnetic monopod apparatus into a support surface ground; wherein the top portion having the gripping portion is made of a thermoplastic elastomer grip material.

10. The magnetic monopod apparatus of claim 1, wherein the electronic device having a magnetic attachment plate is adjustably mounted to the magnetic monopod apparatus and is easily disengaged from the magnetic component by pulling the electronic device away from the magnetic monopod apparatus; and easily engaged by placing the electronic device unto the magnetic component.

11. The magnetic monopod apparatus of claim 1, wherein the swivel socket comprises a notch along an upper periphery of the swivel socket; wherein the threaded protrusion extending from the swivel ball rests within the notch; wherein the electronic device is in position to record a field of view that is along a horizontal plane parallel to the ground surface; wherein the twist lock is rotated to secure the position of the swivel ball and rotated to reposition the orientation of the swivel ball; wherein the electronic device attached to the threaded protrusion of the swivel ball is rotated to reposition the field of view.

12. The magnetic monopod apparatus of claim 10, wherein the electronic device is mounted onto the magnetic monopod apparatus for photographing and video recording sports motion for analysis and improvement.

13. A magnetic monopod apparatus for mounting an electronic device consisting:
a monopod support rod having a ground insertion base portion for inserting the support rod into a ground surface, a top portion having a gripping portion, an upper end having a threaded protrusion; thereby providing a stable hands-free photography, video recording, and documenting mount for the electronic device;
a swivel socket with a swivel socket base attached to the upper end of the support rod by engaging with the threaded protrusion; the swivel socket having a swivel ball adjustable positioned within the swivel socket; the swivel ball having a cylindrical threaded base plate securely fastened on a protrusion extending from the swivel ball; a twist lock that engages with the swivel socket and swivel socket base to adjust angular rotational of the swivel ball; wherein the swivel ball rotates 180 degrees about a pivot point along an X-axis and a range of rotation 360 degrees about a Y-axis;
wherein a magnetic component is adjacent to the cylindrical threaded base plate, thereby providing an attachment means to securely fasten and support the mounting of the electronic device to the monopod support rod.

14. A magnetic monopod apparatus for mounting an electronic device consisting:
a monopod support rod having a ground insertion base portion for inserting the support rod into a ground surface, a top portion having a gripping portion, an upper end having a threaded protrusion; thereby providing a stable hands-free photography, video recording, and documenting mount for the electronic device;
a swivel socket with a swivel socket base attached to the upper end of the support rod by engaging with the threaded protrusion; the swivel socket having a swivel ball adjustable positioned within the swivel socket; the swivel ball having a cylindrical threaded base plate securely fastened on a protrusion extending from the swivel ball; a twist lock that engages with the swivel socket and swivel socket base to adjust angular rotational of the swivel ball;
wherein a magnetic component is adjacent to the cylindrical threaded base plate, thereby providing an attachment means to securely fasten and support the mounting of the electronic device to the monopod support rod.
